(19) United States
(12) Patent Application Publication
(10) Pub. No.: US 2020/0048429 A1
(43) Pub. Date: Feb. 13, 2020

(54) RUBBER COMPOSITION AND METHOD FOR PRODUCING RUBBER COMPOSITION

(71) Applicant: TOYO TIRE CORPORATION, Itami-shi (JP)

(72) Inventor: Yuki Komiya, Itami-shi (JP)

(73) Assignee: TOYO TIRE CORPORATION, Itami-shi (JP)

(21) Appl. No.: 16/519,390

(22) Filed: Jul. 23, 2019

(30) Foreign Application Priority Data
Aug. 8, 2018 (JP) 2018-149626
Aug. 8, 2018 (JP) 2018-149631

(51) Int. Cl. C08K 5/20; C08K 3/04; C08K 5/09

(52) U.S. Cl. CPC C08K 5/20; C08L 21/00; C08K 5/09; C08K 3/04

(57) ABSTRACT

A rubber composition comprises at least a rubber ingredient, carbon black and a compound described in formula (I) below. In the formula (I), R¹ and R² represent a hydrogen atom, and an alkyl group, an alkenyl group or an alkynyl group having a carbon number of 1 to 20, and R¹ and R² may be the same or different; M⁺ represents a sodium ion, a potassium ion or a lithium ion. The rubber composition contains carbon black having a surface activity ((N₂SA)/(IA)) of at least 1.0 or more as the carbon black.

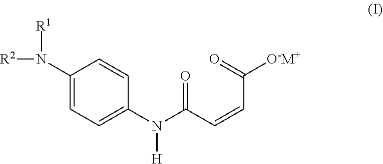

### BACKGROUND OF THE INVENTION

### Field of the Invention

The present invention relates to a rubber composition and a method for producing a rubber composition.

### Description of the Related Art

Generally, carbon black is blended in rubber products such as pneumatic tires for improving the reinforcement. In order to improve the rubber strength and low heat generation of rubber products, the dispersibility of carbon black in rubber ingredients is required to be improved. For the purpose of improving the low heat generation of the eventually resulting vulcanized rubber, the techniques of blending (2Z)-4-[(4-aminophenyl)amino]-4-oxo-2-butenoic acid sodium in a rubber composition have been reported (Patent Documents 1 to 3 described below).

### PRIOR ART DOCUMENT

### Patent Documents

Patent Document 1: JP-A-2016-210834

Patent Document 2: JP-A-2014-95013

Patent Document 3: JP-A-2014-95014

The present inventors have earnestly investigated the techniques in Patent Documents 1-3, and have found that there is still room for improvement of the low heat generation of the eventually resulting vulcanized rubber.

The present invention has been achieved in view of the above-mentioned actual circumstances, and an object thereof is to provide a rubber composition which becomes a raw material for a vulcanized rubber having excellent processability and excellent low heat generation. Another object of the present invention is to provide a method for producing a rubber composition which becomes a raw material for a vulcanized rubber having excellent low heat generation.

### SUMMARY OF THE INVENTION

The objects can be accomplished by the present invention described below. That is, the present invention relates to a rubber composition containing at least a rubber ingredient, carbon black and a compound described in formula (I) below:

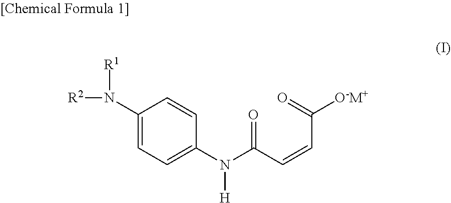

in the formula (I), R¹ and R² represent a hydrogen atom, and an alkyl group, an alkenyl group or an alkynyl group having a carbon number of 1 to 20, and R¹ and R² may be the same or different; M⁺ represents a sodium ion, a potassium ion or a lithium ion,

in which the rubber composition contains carbon black having a surface activity ((N₂SA)/(IA)) of at least 1.0 or more as the carbon black.

The compound described in the formula (I) can react with a radical generated by cutting a molecular chain of a polymer constituting the rubber ingredient, and with various functional groups presented on the surface of the carbon black. Therefore, the polymer constituting the rubber ingredient is reacted with the carbon black via the compound described in the formula (I) to improve the dispersibility of the carbon black in the rubber composition. The present inventors have focused on the surface activity of the carbon black, and have found that the dispersibility of the carbon black in the rubber composition can be improved using the carbon black having a (N₂SA/IA) of 1.0 or more even if the blending amount of the compound described in the formula (I) in the rubber composition is decreased. If the blending amount of the compound described in the formula (I) in the rubber composition is increased, the Mooney viscosity of the rubber composition tends to be increased, and the deterioration in processability of the rubber composition is concerned. However, when the carbon black having high surface activity is used, the processability of the rubber composition of the present invention is improved.

In the rubber composition, a content of the compound described in the formula (I) is preferably 0.1 parts by mass or more and 0.30 parts by mass or less based on 100 parts by mass of a total amount of the rubber ingredient. In this case, the processability of the rubber composition is further improved because the blending amount of the compound described in the formula (I) is decreased.

Further, the present invention relates to a method for producing a rubber composition, including:

a first mixing step of mixing at least a rubber ingredient, carbon black and a compound described in formula (I) below:

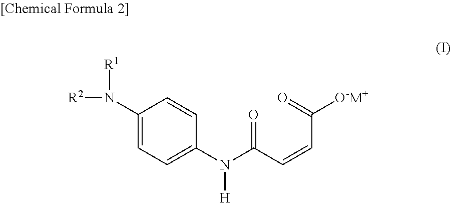

in the formula (I), R¹ and R² represent a hydrogen atom, and an alkyl group, an alkenyl group or an alkynyl group having a carbon number of 1 to 20, and R¹ and R² may be the same or different; M⁺ represents a sodium ion, a potassium ion or a lithium ion, and

a second mixing step of further mixing at least a wax after the first mixing step,

in which a blending amount of the compound described in the formula (I) is 0.1 parts by mass or more and 0.75 parts by mass or less based on 100 parts by mass of a total amount of the rubber ingredient.

The compound described in the formula (I) can react with a radical generated by cutting a molecular chain of a polymer constituting the rubber ingredient, and with various functional groups presented on the surface of the carbon black. Therefore, the polymer constituting the rubber ingredient is reacted with the carbon black via the compound described in the formula (I) to improve the dispersibility of the carbon black in the rubber composition. The present inventors have investigated these reactions in detail, and have found that the reactivity of at least one of the radical generated by cutting the molecular chain of the polymer constituting the rubber ingredient and the various functional groups presented on the surface of the carbon black tends to be decreased in the presence of the wax. Therefore, in the present invention, at least the rubber ingredient, the carbon black and the compound described in the formula (I) are sufficiently reacted in the absence of the wax in the first mixing step, and then the wax is mixed (second mixing step). As a result, in the method for producing a rubber composition of the present invention, the rubber composition containing carbon black having excellent dispersibility in the rubber ingredients can be produced, and therefore the low heat generation of the eventually resulting vulcanized rubber is improved. In addition, increase in the viscosity of the rubber composition during the production can be suppressed because the blending amount of the compound described in the formula (I) is limited to be low (0.1 parts by mass or more and 0.75 parts by mass or less) based on 100 parts by mass of the total amount of the rubber ingredient. Therefore, in the first mixing step, the dispersibility of the carbon black in the rubber composition can be further improved while maintaining the processability of the rubber composition.

In the production method, stearic acid is further mixed in the second step. The present inventors have investigated the above mixing, and have found that the reactivity of at least one of the radical generated by cutting the molecular chain of the polymer constituting the rubber ingredient and the various functional groups presented on the surface of the carbon black tends to be decreased when the compound described in the formula (I) and the carbon black are reacted in the simultaneous presence of the wax and the stearic acid. Therefore, the dispersibility of the carbon black in the rubber composition can be further improved by sufficiently reacting at least the rubber ingredient, the carbon black, and the compound described in the formula (I) in the absence of the wax and the stearic acid in the first mixing step, and then mixing the wax and the stearic acid.

### DETAILED DESCRIPTION OF THE PREFERRED EMBODIMENTS

A rubber composition according to the present invention contains at least a rubber ingredient, a carbon black, and a compound described in formula (I).

As the rubber ingredient, for example, a diene-based rubber can be suitably used. Examples of the diene-based rubber include natural rubber (NR), polyisoprene rubber (IR), polystyrene butadiene rubber (SBR), polybutadiene rubber (BR), chloroprene rubber (CR), and nitrile rubber (NBR). If needed, a terminal-modified rubber (for example, a terminal-modified BR, a terminal-modified SBR), or a modified rubber so as to provide demanded properties (for example, a modified NR) can be suitably used. Also, as the polybutadiene rubber (BR), a rubber synthesized with a polymerization catalyst composition containing a metallocene complex described in WO2007-129670 can be used in addition to a rubber synthesized with a cobalt (Co) catalyst, a neodymium (Nd) catalyst, a nickel (Ni) catalyst, a titanium (Ti) catalyst, or a lithium (Li) catalyst.

As the carbon black, carbon black having a surface activity ((N₂SA)/(IA)) of 1.0 or more is used. A ratio of nitrogen adsorption specific surface area (N₂SA) to iodine adsorption (IA) ((N₂SA)/(IA)) of carbon black represents the surface activity of the carbon black. The higher the ratio is, the greater the interaction between the rubber and the carbon black is. Examples of the carbon black having a surface activity ((N₂SA)/(IA)) of 1.0 or more include N120 ((N₂SA); 126 m²/g, (IA); 122 mg/g), N121 ((N₂SA); 122 m²/g, (IA); 121 mg/g), N125 ((N₂SA); 122 m²/g, (IA); 117 mg/g), N134 ((N₂SA); 143 m²/g, (IA); 142 mg/g), N339 ((N₂SA); 91 m²/g, (IA); 90 mg/g), N343 ((N₂SA); 96 m²/g, (IA); 92 mg/g), N351 ((N₂SA); 71 m²/g, (IA); 68 mg/g), N375 ((N₂SA); 93 m²/g, (IA); 90 mg/g), N642 ((N₂SA); 39 m²/g, (IA); 36 mg/g), N650 ((N₂SA); 36 m²/g, (IA); 36 mg/g), N683 ((N₂SA); 36 m²/g, (IA); 35 mg/g), N754 ((N₂SA); 25 m²/g, (IA); 24 mg/g), N762 ((N₂SA); 29 m²/g, (IA); 27 mg/g), N765 ((N₂SA); 34 m²/g, (IA); 31 mg/g), N772 ((N₂SA); 32 m²/g, (IA); 30 mg/g), N774 ((N₂SA); 30 m²/g, (IA); 29 mg/g), and N787 (N₂SA); 32 m²/g, (IA); 30 mg/g), defined in ASTM D1765. The nitrogen adsorption specific surface area (N₂SA) and the iodine adsorption (IA) can be measured in accordance with JIS K6217-2 and JIS K6217-1, respectively. In the case of considering the rubber properties of the eventually resulting vulcanized rubber, the content of the carbon black in the rubber composition is preferably from 10 to 100 parts by mass, and more preferably from 20 to 100 parts by mass based on 100 parts by mass of the total amount of the rubber ingredient in the rubber composition. In the present invention, as the carbon black, carbon black other than one having a surface activity ((N₂SA)/(IA)) of 0.1 or more can be used. However, in order to sufficiently provide the effect of the present invention, in the carbon black to be used, the use amount of the carbon black having a surface activity ((N₂SA)/(IA)) of 0.1 or more is preferably 5 mass % or more, and more preferably 10 mass % or more.

The compound described in the formula (I) can be represented by the following structural formula:

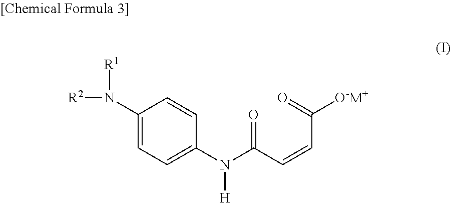

in the formula (I), R¹ and R² represent a hydrogen atom, and an alkyl group, an alkenyl group or an alkynyl group having a carbon number of 1 to 20, and R¹ and R² may be the same or different; M⁺ represents a sodium ion, a potassium ion or a lithium ion.

In order to improve the affinity to the carbon black, a compound described in the following formula (I′):

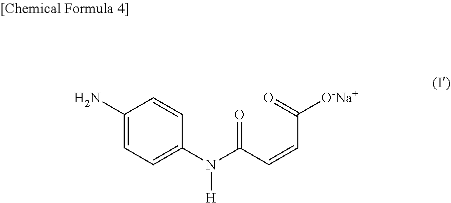

in which R¹ and R² in the formula (I) are each a hydrogen atom; and M⁺ is a sodium ion, is particularly preferably used.

In order to improve the balance between the processability of the rubber composition and the low heat generation of the vulcanized rubber, the blending amount of the compound described in the formula (I) is preferably 0.1 parts by mass or more and 0.3 parts by mass or less, and more preferably 0.1 parts by mass or more and 0.25 parts by mass or less based on 100 parts by mass of the rubber ingredient in the rubber composition.

The rubber composition of the present invention can be produced by using a common Banbury mixer and dry mixing at least the rubber ingredients, the carbon black and the compound described in the formula (I). During the dry mixing, the rubber composition can be produced by mixing and dispersing, in addition to the above components, a formulating agent other than a vulcanizing-type formulating agent, and then mixing the vulcanizing-type formulating agent. Examples of the formulating agent other than the vulcanizing-type formulating agent include silica, a silane coupling agent, an aging prevention agent, zinc oxide, an softening agent such as stearic acid, a wax, or an oil, a processing aid, and an additional rubber.

As the aging prevention agent, aging prevention agents commonly used for rubbers, including an aromatic amine-based aging prevention agent, an amine-ketone-based aging prevention agent, a monophenol-based aging prevention agent, a bisphenol-based aging prevention agent, a polyphenol-based aging prevention agent, a dithiocarbamate salt-based aging prevention agent, and a thiourea-based aging prevention agent, can be used alone, or can be used in a suitable mixture thereof.

Examples of the vulcanizing-type formulating agent include a vulcanizing agent such as sulfur or an organic peroxide, a vulcanizing accelerator, a vulcanizing accelerating aid, and a vulcanizing retarding agent.

Sulfur as a sulfur-based vulcanizing agent should be common sulfur for rubber. For example, powdery sulfur, precipitated sulfur, insoluble sulfur, or highly dispersible sulfur can be used.

Examples of the vulcanizing accelerator include vulcanizing accelerators commonly used for rubbers, including a sulfenamide-based vulcanizing accelerator, a thiuram-based vulcanizing accelerator, a thiazole-based vulcanizing accelerator, a thiourea-based vulcanizing accelerator, a guanidine-based vulcanizing accelerator, and a dithiocarbamate salt-based vulcanizing accelerator can be used alone, or can be used in a suitable mixture thereof.

Next, a method for producing a rubber composition according to the present invention will be described. The production method includes a first mixing step of mixing at least a rubber ingredient, carbon black and a compound described in formula (I); and a second mixing step of further mixing at least a wax after the first mixing step.

As the rubber ingredient, for example, a diene-based rubber can be suitably used. Examples of the diene-based rubber include natural rubber (NR), polyisoprene rubber (IR), polystyrene butadiene rubber (SBR), polybutadiene rubber (BR), chloroprene rubber (CR), and nitrile rubber (NBR). If needed, a terminal-modified rubber (for example, a terminal-modified BR, a terminal-modified SBR), or a modified rubber so as to provide demanded properties (for example, a modified NR) can be suitably used. Also, as the polybutadiene rubber (BR), a rubber synthesized with a polymerization catalyst composition containing a metallocene complex described in WO2007-129670 can be used in addition to a rubber synthesized with a cobalt (Co) catalyst, a neodymium (Nd) catalyst, a nickel (Ni) catalyst, a titanium (Ti) catalyst, or a lithium (Li) catalyst.

As the carbon black, conductive carbon black such as acetylene black and ketjen black can be used in addition to carbon black used in common rubber industries, including SAF, ISAF, HAF, FEF, and GPF. The carbon black may be granulated carbon black obtained by granulation considering handling properties in common rubber industries, or non-granulated carbon black. In the case of considering the rubber properties of the eventually resulting vulcanized rubber, the content of the carbon black in the rubber composition is preferably from 10 to 100 parts by mass, and more preferably from 20 to 70 parts by mass based on 100 parts by mass of the total amount of the rubber ingredient in the rubber composition. It is noted that in the present invention, the rubber ingredient, the carbon black and the compound described in the formula (I) are required to be reacted in the first mixing step. However, part of the carbon black may be mixed in the second mixing step.

The compound described in the formula (I) can be represented by the following structural formula:

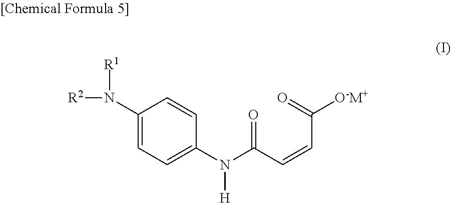

in the formula (I), R¹ and R² represent a hydrogen atom, and an alkyl group, an alkenyl group or an alkynyl group having a carbon number of 1 to 20, and R¹ and R² may be the same or different; M⁺ represents a sodium ion, a potassium ion or a lithium ion.

In order to improve the affinity to the carbon black, a compound described in the following formula (I′):

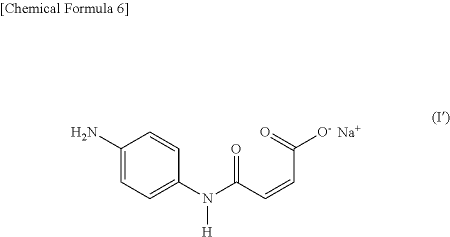

in which R¹ and R² in the formula (I) are each a hydrogen atom; and M⁺ is a sodium ion is particularly preferably used.

In order to improve the low heat generation of the eventually resulting vulcanized rubber, the blending amount of the compound described in the formula (I) is preferably 0.1 parts by mass or more and 0.75 parts by mass or less, and more preferably 0.1 parts by mass or more and 0.5 parts by mass or less based on 100 parts by mass of the rubber ingredient in the rubber composition.

As the wax, a microcrystalline wax or a paraffin wax, which is commonly used in rubber industries, can be used. As the blending amount of the wax in the rubber composition, for example, from 0.1 to 10 parts by mass can be mentioned. The blending amount of stearic acid is not particularly limited, for example, from 0.1 to 10 parts by mass can be mentioned.

In the method for producing a rubber composition of the present invention, the rubber ingredient, the carbon black and the compound described in the formula (I) are mixed in the first mixing step. After the first mixing step, at least the wax and optionally the stearic acid are mixed in the second mixing step. A formulating agent other than a vulcanizing-type formulating agent can be blended either in the first mixing step or the second mixing step. Examples of the formulating agent other than the wax and the stearic acid include an additional rubber, carbon black, silica, a silane coupling agent, an aging prevention agent, zinc oxide, and a processing aid.

As the aging prevention agent, aging prevention agents commonly used for rubbers, including an aromatic amine-based aging prevention agent, an amine-ketone-based aging prevention agent, a monophenol-based aging prevention agent, a bisphenol-based aging prevention agent, a polyphenol-based aging prevention agent, a dithiocarbamate salt-based aging prevention agent, and a thiourea-based aging prevention agent, can be used alone, or can be used in a suitable mixture thereof.

After the first mixing step and the second mixing step, a vulcanizing-type formulating agent is further mixed and dispersed in a third step. Examples of the vulcanizing-type formulating agent include a vulcanizing agent such as sulfur or an organic peroxide, a vulcanizing accelerator, a vulcanizing accelerating aid, and a vulcanizing retarding agent.

Sulfur as a sulfur-based vulcanizing agent should be common sulfur for rubber. For example, powdery sulfur, precipitated sulfur, insoluble sulfur, or highly dispersible sulfur can be used.

Examples of the vulcanizing accelerator include vulcanizing accelerators commonly used for rubbers, including a sulfenamide-based vulcanizing accelerator, a thiuram-based vulcanizing accelerator, a thiazole-based vulcanizing accelerator, a thiourea-based vulcanizing accelerator, a guanidine-based vulcanizing accelerator, and a dithiocarbamate salt-based vulcanizing accelerator can be used alone, or can be used in a suitable mixture thereof.

Since the rubber composition of the present invention, and the rubber composition produced by the production method of the present invention can be a raw material for the vulcanized rubber having excellent low heat generation while maintaining the processability, they are particularly useful for a raw material for rubber members such as a tread part and sidewall part of pneumatic tires.

### EXAMPLES

The rubber composition of the present invention will be described in more detail by way of Examples.

### (Used Materials)

a) natural rubber; RSS #3

b) butadiene rubber; “BR150B” (manufactured by UBE INDUSTRIES, LTD.)

c) compound described in formula (I); (2Z)-4-[(4-aminophenyl)amino]-4-oxo-2-butenoic acid sodium (manufactured by Sumitomo Chemical Co., Ltd.)

d) carbon black (N110) ((N₂SA); 127 m²/g, (IA); 145 mg/g, ((N₂SA)/(IA))=0.88); “Seast 9” (manufactured by Tokai Carbon Co., Ltd.)

carbon black (N121) ((N₂SA); 122 m²/g, (IA); 121 mg/g, ((N₂SA)/(IA))=1.01); (manufactured by CSRC)
carbon black (N134) ((N₂SA); 143 m²/g, (IA); 142 mg/g, ((N₂SA)/(IA))=1.01); “Seast 9H” (manufactured by Tokai Carbon Co., Ltd.)

e) zinc oxide; two types of zinc oxide (manufactured by MITSUI MINING & SMELTING CO., LTD.)

f) stearic acid; “LUNAC S-20” (manufactured by Kao Corporation)

g) wax; “OZOACE0355” (manufactured by NIPPON SEIRO CO., LTD.)

h) aging prevention agent; “6PPD” (manufactured by FlexSys)

i) sulfur; “5% oil-containing sulfur microparticle” (manufactured by Tsurumi Chemical Industry Co., ltd.)

j) vulcanizing accelerator; “Sanceler NS-G” (manufactured by SANSHIN CHEMICAL INDUSTRY CO., LTD.)

### Examples 1 to 8

Rubber compositions each containing at least a rubber ingredient, carbon black, and a compound described in the formula (I) were produced by kneading with a common Banbury mixer, as described in Table 1 and Table 2.

### Comparative Examples 1 to 4

Rubber compositions were prepared in the same manner as in Examples except that the compound described in the formula (I) is not blended.

### Reference Examples 1 to 6

Rubber compositions were prepared in the same manner as in Examples except that carbon black having a ((N₂SA)/(IA)) of less than 1 was used.

A vulcanized rubber sample having a predetermined shape was produced by vulcanizing the resulting rubber composition. The processability of the rubber composition and the low heat generation of the vulcanized rubber were evaluated under the following conditions.

### Processability of Rubber Composition (Mooney Viscosity)

The Mooney viscosity was measured in accordance with JIS K-6300-1. The evaluation is performed by indexing the Mooney viscosity in Example 1 and 2 assuming that the Mooney viscosity of the non-vulcanized rubber obtained in Comparative Example 1 is 100. It means that the lower the value is, the greater the processability of rubber is. Similarly, Comparative Example 2 was used as a reference for Example 3 and 4, Comparative Example 3 was used as a reference for Example 5 and 6, Comparative Example 4 was used as a reference for Example 7 and 8, Reference Example 1 was used as a reference for Reference Example 2 and 3, and Reference Example 4 was used as a reference for Reference Example 5 and 6.

### Low Heat Generation of Vulcanized Rubber (Tan δ)

The low heat generation of the produced vulcanized rubber was evaluated in accordance with JIS K-6394 by loss coefficient tan δ. More specifically, a viscoelastic tester manufactured by Toyo Seiki Seisaku-sho, Ltd. was used and tan δ was measured at a frequency of 10 Hz, a static strain of 10%, a dynamic strain of 1%, and a temperature of 60° C. The evaluation is performed by indexing the tan δ in Example 1 and 2 assuming that the tan δ of the vulcanized rubber obtained in Comparative Example 1 is 100. It means that the lower the value is, the greater the low heat generation of vulcanized rubber is. Similarly, Comparative Example 2 was used as a reference for Example 3 and 4, Comparative Example 3 was used as a reference for Example 5 and 6, Comparative Example 4 was used as a reference for Example 7 and 8, Reference Example 1 was used as a reference for Reference Example 2 and 3, and Reference Example 4 was used as a reference for Reference Example 5 and 6.

TABLE 1

| | | | | | | Compar- | | | Compar- | | |
|---|---|---|---|---|---|---|---|---|---|---|---|
| | | | Reference | Reference | Reference | ative | Example | Example | ative | Example | Example |
| | | | Example 1 | Example 2 | Example 3 | Example 1 | 1 | 2 | Example 2 | 3 | 4 |
| Rubber | Natural rubber | phr | 100 | 100 | 100 | 100 | 100 | 100 | 100 | 100 | 100 |
| composition | Compound | phr | | 0.1 | 0.24 | | 0.1 | 0.24 | | 0.1 | 0.24 |
| formulation | described | | | | | | | | | | |
| | in formula (I) | | | | | | | | | | |
| | Carbon black | phr | 45 | 45 | 45 | | | | | | |
| | (N110) | | | | | | | | | | |
| | Carbon black | phr | | | | 45 | 45 | 45 | | | |
| | (N121) | | | | | | | | | | |
| | Carbon black | phr | | | | | | | 45 | 45 | 45 |
| | (N134) | | | | | | | | | | |
| | Zinc oxide | phr | 3.0 | 3.0 | 3.0 | 3.0 | 3.0 | 3.0 | 3.0 | 3.0 | 3.0 |
| | Stearic acid | phr | 2.0 | 2.0 | 2.0 | 2.0 | 2.0 | 2.0 | 2.0 | 2.0 | 2.0 |
| | Wax | phr | 2.0 | 2.0 | 2.0 | 2.0 | 2.0 | 2.0 | 2.0 | 2.0 | 2.0 |
| | Aging | phr | 2.0 | 2.0 | 2.0 | 2.0 | 2.0 | 2.0 | 2.0 | 2.0 | 2.0 |
| | prevention | | | | | | | | | | |
| | agent | | | | | | | | | | |
| | Sulfur | phr | 1.5 | 1.5 | 1.5 | 1.5 | 1.5 | 1.5 | 1.5 | 1.5 | 1.5 |
| | Vulcanizing | phr | 0.5 | 0.5 | 0.5 | 0.5 | 0.5 | 0.5 | 0.5 | 0.5 | 0.5 |
| | accelerator | | | | | | | | | | |
| Evaluation | Processability | Mooney | 100 | 101 | 103 | 100 | 100 | 104 | 100 | 102 | 103 |
| properties | of rubber | viscosity | | | | | | | | | |
| | composition | | | | | | | | | | |
| | Low heat | tanδ | 100 | 98 | 95 | 100 | 92 | 83 | 100 | 94 | 82 |
| | generation | | | | | | | | | | |
| | of vulcanized | | | | | | | | | | |
| | rubber | | | | | | | | | | |

TABLE 2

| | | | | | | Compar- | | | Compar- | | |
|---|---|---|---|---|---|---|---|---|---|---|---|
| | | | Reference | Reference | Reference | ative | | | ative | | |
| | | | Example 4 | Example 5 | Example 6 | Example 3 | Example 5 | Example 6 | Example 4 | Example 7 | Example 8 |
| Rubber | Natural rubber | phr | 80 | 80 | 80 | 80 | 80 | 80 | 80 | 80 | 80 |
| composition | Butadiene | phr | 20 | 20 | 20 | 20 | 20 | 20 | 20 | 20 | 20 |
| formulation | rubber | | | | | | | | | | |
| | Compound | phr | | 0.1 | 0.24 | | 0.1 | 0.24 | | 0.1 | 0.24 |
| | described | | | | | | | | | | |
| | in formula (I) | | | | | | | | | | |
| | Carbon black | phr | 45 | 45 | 45 | | | | | | |
| | (N110) | | | | | | | | | | |
| | Carbon black | phr | | | | 45 | 45 | 45 | | | |
| | (N121) | | | | | | | | | | |
| | Carbon black | phr | | | | | | | 45 | 45 | 45 |
| | (N134) | | | | | | | | | | |
| | Zinc oxide | phr | 3.0 | 3.0 | 3.0 | 3.0 | 3.0 | 3.0 | 3.0 | 3.0 | 3.0 |
| | Stearic acid | phr | 2.0 | 2.0 | 2.0 | 2.0 | 2.0 | 2.0 | 2.0 | 2.0 | 2.0 |
| | Wax | phr | 2.0 | 2.0 | 2.0 | 2.0 | 2.0 | 2.0 | 2.0 | 2.0 | 2.0 |
| | Aging | phr | 2.0 | 2.0 | 2.0 | 2.0 | 2.0 | 2.0 | 2.0 | 2.0 | 2.0 |
| | prevention | | | | | | | | | | |
| | agent | | | | | | | | | | |
| | Sulfur | phr | 1.5 | 1.5 | 1.5 | 1.5 | 1.5 | 1.5 | 1.5 | 1.5 | 1.5 |
| | Vulcanizing | phr | 0.5 | 0.5 | 0.5 | 0.5 | 0.5 | 0.5 | 0.5 | 0.5 | 0.5 |
| | accelerator | | | | | | | | | | |
| Evaluation | Processability | Mooney | 100 | 101 | 102 | 100 | 101 | 103 | 100 | 102 | 104 |
| properties | of rubber | viscosity | | | | | | | | | |
| | composition | | | | | | | | | | |
| | Low heat | tanδ | 100 | 98 | 96 | 100 | 91 | 82 | 100 | 95 | 83 |
| | generation | | | | | | | | | | |
| | of vulcanized | | | | | | | | | | |
| | rubber | | | | | | | | | | |

From the results of Reference Examples 1 to 8, when the carbon black having a ((N₂SA)/(IA)) of less than 1 was used, the low heat generation of the vulcanized rubber was not notably improved even if the compound described in the formula (I) was used in combination. On the other hand, from the results of Examples 1 to 8, when the carbon black having a ((N₂SA)/(IA)) of 1.0 or more was used, the low heat generation of the vulcanized rubber was notably improved when the compound described in the formula (I) was used in combination. In Examples 1 to 8, the Mooney viscosity of the non-vulcanized rubber (rubber composition) is slightly increased, but the level is sufficiently practicable.

Next, the production method of the present invention will be described in more detail by way of Examples.

### (Used Materials)

a) natural rubber; RSS #3

b) butadiene rubber; “BR150B” (manufactured by UBE INDUSTRIES, LTD.)

c) compound described in formula (I); (2Z)-4-[(4-aminophenyl)amino]-4-oxo-2-butenoic acid sodium (manufactured by Sumitomo Chemical Co., Ltd.)

d) carbon black (N234); “Seast 7HM” (manufactured by Tokai Carbon Co., Ltd.)

e) zinc oxide; two types of zinc oxide (manufactured by MITSUI MINING & SMELTING CO., LTD.)

f) stearic acid; “LUNAC S-20” (manufactured by Kao Corporation)

g) wax; “OZOACE0355” (manufactured by NIPPON SEIRO CO., LTD.)

h) aging prevention agent; “6PPD” (manufactured by FlexSys)

i) sulfur; “5% oil-containing sulfur microparticle” (manufactured by Tsurumi Chemical Industry Co., ltd.)

j) vulcanizing accelerator; “Sanceler NS-G” (manufactured by SANSHIN CHEMICAL INDUSTRY CO., LTD.)

### Examples 9 to 12

At least a rubber ingredient, carbon black, and a compound described in the formula (I) were mixed by kneading with a common Banbury mixer, as described in Table 3 (first mixing step). After the first mixing step, at least a wax is further added and mixed (second mixing step). After the second mixing step, sulfur and a vulcanizing accelerator were added and mixed as a vulcanizing-type formulating agent (third mixing step) to prepare rubber compositions.

### Comparative Examples 5 to 12

Rubber compositions were prepared in the same manner as in Examples except that the compound described in the formula (I) was not blended, or the compound described in the formula (I) and the wax were added simultaneously in the first mixing step.

A vulcanized rubber sample having a predetermined shape was produced by vulcanizing the resulting rubber composition. The low heat generation of the vulcanized rubber was evaluated under the following conditions.

### Low Heat Generation of Vulcanized Rubber (Tan δ)

The low heat generation of the produced vulcanized rubber was evaluated in accordance with JIS K-6394 by loss coefficient tan δ. More specifically, a viscoelastic tester manufactured by Toyo Seiki Seisaku-sho, Ltd. was used and tan δ was measured at a frequency of 10 Hz, a static strain of 10%, a dynamic strain of 1%, and a temperature of 60° C. The evaluation was performed by indexing the tan δ in Example 9 and 10 and Comparative Examples 6 to 8 assuming that the tan δ of the vulcanized rubber obtained in Comparative Example 5 was 100. The evaluation was performed by indexing the tan δ in Example 11 and 12 and Comparative Examples 10 to 12 assuming that the tan δ of the vulcanized rubber obtained in Comparative Example 9 was 100. It means that the lower the value is, the greater the low heat generation of vulcanized rubber is.

TABLE 3

| | | | Comparative | Comparative | Comparative | Comparative | | Example |
|---|---|---|---|---|---|---|---|---|
| | | | Example 5 | Example 6 | Example 7 | Example 8 | Example 9 | 10 |
| First | Natural | phr | 100 | 100 | 100 | 100 | 100 | 100 |
| mixing | rubber | | | | | | | |
| step | Butadiene | phr | | | | | | |
| | rubber | | | | | | | |
| | Compound | phr | | 0.5 | | | 0.5 | 0.5 |
| | described | | | | | | | |
| | in formula | | | | | | | |
| | (I) | | | | | | | |
| | Carbon | phr | 45 | 45 | 45 | 45 | 45 | 45 |
| | black | | | | | | | |
| | Stearic | phr | 2.0 | 2.0 | | 2.0 | 2.0 | |
| | acid | | | | | | | |
| | Wax | phr | 2.0 | 2.0 | 2.0 | | | |
| | Aging | phr | 2.0 | 2.0 | 2.0 | 2.0 | 2.0 | 2.0 |
| | prevention | | | | | | | |
| | agent | | | | | | | |
| | Zinc oxide | phr | 3.0 | 3.0 | 3.0 | 3.0 | 3.0 | 3.0 |
| Second | Carbon | phr | 5.0 | 5.0 | 5.0 | 5.0 | 5.0 | 5.0 |
| mixing | black | | | | | | | |
| step | Stearic | phr | | | 2.0 | | | 2.0 |
| | acid | | | | | | | |
| | Wax | phr | | | | 2.0 | 2.0 | 2.0 |
| Third | Sulfur | phr | 1.5 | 1.5 | 1.5 | 1.5 | 1.5 | 1.5 |
| mixing | Vulcanizing | phr | 0.5 | 0.5 | 0.5 | 0.5 | 0.5 | 0.5 |
| step | accelerator | | | | | | | |
| | Evaluation | tanδ | 100 | 92 | 101 | 100 | 85 | 82 |
| | properties | | | | | | | |
| | | | Comparative | Comparative | Comparative | Comparative | Example | Example |
| | | | Example 9 | Example 10 | Example 11 | Example 12 | 11 | 12 |
| First | Natural | phr | 80 | 80 | 80 | 80 | 80 | 80 |
| mixing | rubber | | | | | | | |
| step | Butadiene | phr | 20 | 20 | 20 | 20 | 20 | 20 |
| | rubber | | | | | | | |
| | Compound | phr | | 0.5 | | | 0.5 | 0.5 |
| | described | | | | | | | |
| | in formula | | | | | | | |
| | (I) | | | | | | | |
| | Carbon | phr | 45 | 45 | 45 | 45 | 45 | 45 |
| | black | | | | | | | |
| | Stearic | phr | 2.0 | 2.0 | | 2.0 | 2.0 | |
| | acid | | | | | | | |
| | Wax | phr | 2.0 | 2.0 | 2.0 | | | |
| | Aging | phr | 2.0 | 2.0 | 2.0 | 2.0 | 2.0 | 2.0 |
| | prevention | | | | | | | |
| | agent | | | | | | | |
| | Zinc oxide | phr | 3.0 | 3.0 | 3.0 | 3.0 | 3.0 | 3.0 |
| Second | Carbon | phr | 5.0 | 5.0 | 5.0 | 5.0 | 5.0 | 5.0 |
| mixing | black | | | | | | | |
| step | Stearic | phr | | | 2.0 | | | 2.0 |
| | acid | | | | | | | |
| | Wax | phr | | | | 2.0 | 2.0 | 2.0 |
| Third | Sulfur | phr | 1.5 | 1.5 | 1.5 | 1.5 | 1.5 | 1.5 |
| mixing | Vulcanizing | phr | 0.5 | 0.5 | 0.5 | 0.5 | 0.5 | 0.5 |
| step | accelerator | | | | | | | |
| | Evaluation | tanδ | 100 | 91 | 100 | 102 | 87 | 83 |
| | properties | | | | | | | |

From the comparison between Comparative Example 6 and Example 9, and further the comparison between Comparative Example 10 and Example 11, it is understood that Examples 9 and 11 in which the compound described in the formula (I) and the wax are mixed in separate steps are superior in the low heat generation of the vulcanized rubber to Comparative Examples 6 and 10 in which the compound described in the formula (I) and the wax are mixed simultaneously. From the comparison between Example 9 and Example 10, and further the comparison between Example 11 and Example 12, it is understood that the low heat generation of the vulcanized rubber is further improved by separately mixing the compound described in the formula (I) with not only the wax but also the stearic acid.

What is claimed is:

1. A rubber composition comprising at least a rubber ingredient, carbon black and a compound described in formula (I) below: 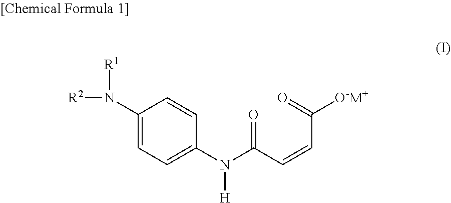
in the formula (I), R¹ and R² represent a hydrogen atom, and an alkyl group, an alkenyl group or an alkynyl group having a carbon number of 1 to 20, and R¹ and R² may be the same or different; M⁺ represents a sodium ion, a potassium ion or a lithium ion,
wherein the rubber composition contains carbon black having a surface activity ((N₂SA)/(IA)) of at least 1.0 or more as the carbon black.

2. The rubber composition according to claim 1, wherein a content of the compound described in the formula (I) is 0.1 parts by mass or more and 0.30 parts by mass or less based on 100 parts by mass of a total amount of the rubber ingredient.

3. The rubber composition according to claim 1, wherein a content of the carbon black is from 10 to 100 parts by mass based on 100 parts by mass of a total amount of the rubber ingredient.

4. The rubber composition according to claim 1, wherein a use amount of the carbon black having a surface activity ((N₂SA)/(IA)) of 1.0 or more is 5 mass % or more in the carbon black.

5. A method for producing a rubber composition, comprising:
a first mixing step of mixing at least a rubber ingredient, carbon black and a compound described in formula (I) below: 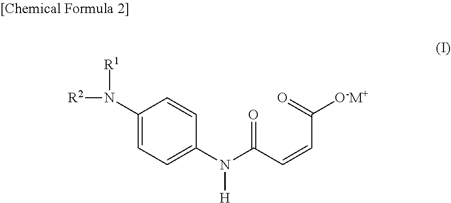
in the formula (I), R¹ and R² represent a hydrogen atom, and an alkyl group, an alkenyl group or an alkynyl group having a carbon number of 1 to 20, and R¹ and R² may be the same or different; M⁺ represents a sodium ion, a potassium ion or a lithium ion, and
a second mixing step of further mixing at least a wax after the first mixing step,
wherein a blending amount of the compound described in the formula (I) is 0.1 parts by mass or more and 0.75 parts by mass or less based on 100 parts by mass of a total amount of the rubber ingredient.

6. The method for producing a rubber composition according to claim 5, wherein stearic acid is further mixed in the second step.

7. The method for producing a rubber composition according to claim 5, wherein a blending amount of the wax is 0.1 parts by mass or more and 10 parts by mass or less based on the 100 parts by mass of the total amount of the rubber ingredient.

8. The method for producing a rubber composition according to claim 6, wherein a blending amount of the stearic acid is 0.1 parts by mass or more and 10 parts by mass or less based on the 100 parts by mass of the total amount of the rubber ingredient.
